(19) United States
(12) Patent Application Publication
(10) Pub. No.: US 2023/0393896 A1
(43) Pub. Date: Dec. 7, 2023

(54) DYNAMIC SCHEDULING OF MULTIPLE MACHINE LEARNING MODELS

(71) Applicant: Cisco Technology, Inc., San Jose, CA (US)

(72) Inventors: Ashutosh Arwind Malegaonkar, Milpitas, CA (US); Patrick James Riel, Concord, CA (US); Xinyuan Huang, San Jose, CA (US); Elvira Dzhuraeva, San Jose, CA (US)

(21) Appl. No.: 17/830,716

(22) Filed: Jun. 2, 2022

(51) Int. Cl. G06F 9/50; G06N 20/00

(52) U.S. Cl. CPC G06F 9/5038; G06N 20/00

(57) ABSTRACT

Systems, methods, and computer-readable media are disclosed for a dynamic and intelligent machine learning scheduling platform for running multiple machine learning models simultaneously. The present technology includes receiving output data of a first machine learning model running on an edge device. Further, the present technology includes accessing a set of dynamic rules for scheduling a second machine learning model to run on the edge device. As follows, the present technology includes determining to run the second machine learning model on the edge device in accordance with the set of rules where the first machine learning model and the second machine learning model are run on the edge device in parallel.

### TECHNICAL FIELD

The subject matter of this disclosure relates in general to the field of machine learning processing, and more particularly, to systems and methods for a dynamic and intelligent machine learning scheduling platform for running multiple machine learning models simultaneously.

### BACKGROUND

Machine learning (ML) has been increasingly used for various tasks across a wide variety of industries that used to be manually done by humans. Specifically, ML has automated such tasks through algorithms that draw on a large amount of data. ML is the application of artificial intelligence technology that allows applications to become more accurate at predicting outcomes. In general, ML involves the use of machine learning models, which can be trained or otherwise configured to recognize certain types of patterns and predict outcomes based on input data. For example, machine learning models can be implemented to apply complex computations to input data to generate various types of output.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates an example diagram of a machine learning model scheduling environment according to some examples of the present disclosure.

FIG. 2 illustrates an example diagram of a machine learning scheduling platform according to some examples of the present disclosure.

FIG. 3 illustrates an example method of running multiple learning models simultaneously on an edge device according to some examples of the present disclosure.

FIG. 4 shows an example computing system, which can be for example any computing device that can implement components of the system.

FIG. 5 illustrates an example network device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

The present disclosure includes systems, methods, and computer-readable mediums provided for dynamically planning the execution of multiple machine learning models in parallel on an edge device.

In one aspect, a method of running multiple learning models simultaneously on an edge device includes receiving output data of a first machine learning model running on an edge device. Further, the method includes accessing a set of dynamic rules for scheduling a second machine learning model to run on the edge device. As follows, the method includes determining to run the second machine learning model on the edge device in accordance with the set of rules in response to receiving the output data of the first machine learning model where the first machine learning model and the second machine learning model are run on the edge device in parallel.

In another aspect, the method further includes assigning a time slot for each of the first machine learning model and the second machine learning model that run on the edge device in parallel when the set of rules includes time-based rules.

In another aspect, the method includes defining a time slice between running the first machine learning model and running the second machine learning model when the set of rules includes time-based rules.

In another aspect, the method includes analyzing the output data of the first machine learning model to determine a context associated with the edge device when the set of rules includes context-based rules.

In another aspect, the set of rules comprises external factors. Further, the second machine learning model is designed specific to the external factors.

In another aspect, the method includes examining model templates including information associated with multiple machine learning models that can be downloaded onto the edge device when the multiple machine learning models include the second machine learning model.

In one aspect, a system for running multiple learning models simultaneously on an edge device includes one or more computer-readable media comprising computer-readable instructions and one or more processors. The one or more processors are configured to receive output data of a first machine learning model running on an edge device, access a set of dynamic rules for scheduling a second machine learning model to run on the edge device, and determine to run the second machine learning model on the edge device in accordance with the set of rules in response to receiving the output data of the first machine learning model where the first machine learning model and the second machine learning model are run on the edge device in parallel.

In one aspect, one or more non-transitory computer-readable media include computer-readable instructions, which when executed by one or more processors, cause the processors to receive output data of a first machine learning model running on an edge device, access a set of dynamic rules for scheduling a second machine learning model to run on the edge device, and determine to run the second machine learning model on the edge device in accordance with the set of rules in response to receiving the output data of the first machine learning model where the first machine learning model and the second machine learning model are run on the edge device in parallel.

### DESCRIPTION OF EXAMPLE EMBODIMENTS

Machine learning models have been increasingly implemented in a wide variety of applications and run on various types of devices. These ML models run and function in a secure and robust manner to process a massive amount of data and perform complex and intensive tasks. However, in a conventional process of running a machine learning model on a device, a machine learning model can only be run in a fixed manner. In other words, typically, an edge device is not capable of allowing multiple machine models to run in parallel.

Therefore, there exists a need for a machine learning inference engine (e.g., a machine learning scheduling platform) that allows multiple models to be deployed on an edge device. Further, there exists a need for a dynamic and intelligent machine learning inference engine that can schedule running multiple machine learning models on an edge device based on a predefined set of rules such as in a time and context-aware manner. The proposed solution provides scheduling a plurality of machine learning models to run on a GPU in a time and context-aware manner. As follows, the proposed solution aims to optimize the machine learning outcome and accuracy.

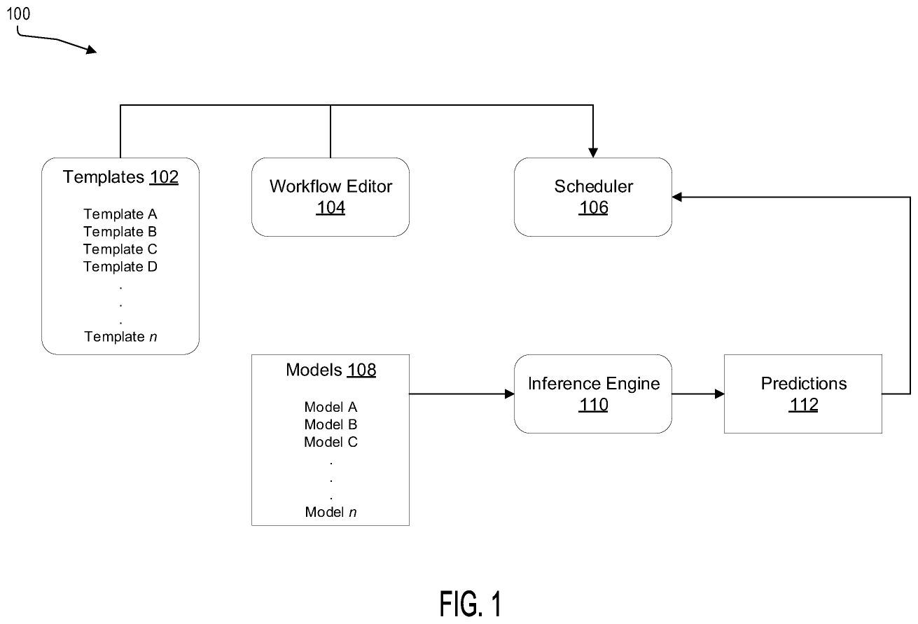

FIG. 1 illustrates an example diagram of a machine learning model scheduling environment 100. As shown in FIG. 1, machine learning model scheduling environment 100 comprises templates 102, workflow editor 104, scheduler 106, models 108 (e.g., machine learning models), inference engine 110, and predictions 112.

In some examples, templates 102 can include a plurality of templates (e.g., Template A, Template B, Template C, Template D, . . . , Template n), which can provide a preset format for designing a machine learning model. For example, the template can be based on an environment or context such as retail, banking, meetings, restaurants, gas stations, etc.

In some instances, workflow editor 104 can create, edit, or execute a workflow of the machine learning model framework. More specifically, workflow editor 104 can build and/or design a machine learning model, which then can be provided to scheduler 106. Also, workflow editor 104 can utilize end-user tools such as IFTTT to facilitate a user to create and design a machine learning model by automating workflow processes. Scheduler 106 can receive templates 102 and output of workflow editor 104 to schedule for running machine learning models on a device.

In some implementations, machine learning model scheduling environment 100 includes one or more machine learning models 108 (e.g., Model A, Model B, Model C, . . . , Model n) available to be implemented on a device. Inference engine 110 can run models 108 and output predictions 112, which then can be provided to scheduler 106.

Scheduler 106 can schedule the implementation of machine learning models on a device based on templates 102, output of workflow editor 104, and output of inference engine 110 based on models 108 (i.e., predictions 112).

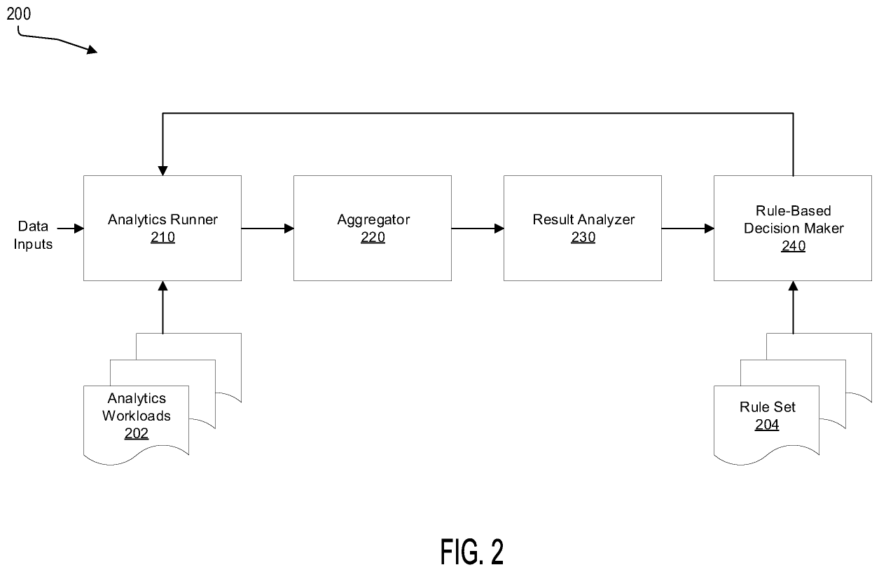

FIG. 2 illustrates an example diagram of a machine learning scheduling platform 200. As shown in FIG. 2, machine learning scheduling platform 200 comprises analytics runner 210, aggregator 220, result analyzer 230, and rule-based decision maker 240. Further, machine learning scheduling platform 200 comprises analytics workloads 202 including one or more machine learning models (e.g., templates 102, output of workflow editor 104, or models 108 as illustrated in FIG. 1) and rule set 204 that defines rules for the implementation and scheduling of machine learning models.

In some examples, analytics runner 210 can be deployed on a device that can implement one or more machine learning models. Examples of the device can include but are not limited to, cameras, smart cameras (e.g., cloud-managed smart cameras), sensors, access points, or any suitable device that is capable of implementing a machine learning model(s).

One or more machine learning models from analytics workloads 202 can be run by analytics runner 210 on a device. Then, the output can be provided to aggregator 220 and result analyzer 230 where output can be aggregated and analyzed.

Thereafter, rule-based decision maker 240 can receive the analyzed output from result analyzer 230 and make a decision based on rule set 204. The decision from rule-based decision maker 240 can be then provided to analytics runner 210. Analytics runner 210 can use the decision, which is received from rule-based decision maker 240 to deploy a new machine learning model from analytics workloads 202.

In some implementations, analytics runner 210 can determine whether multiple machine learning models can be run simultaneously. As noted, rule set 204 can define rules on how the machine learning models can be scheduled and implemented on a device, more specifically, how the multiple machine learnings can be scheduled to run in parallel.

In some instances, the set of rules can be time-based. A time-based rule can include assigning a time slot for machine learning model(s). More specifically, analytics runner 210 (or scheduler 106 as illustrated in FIG. 1) can assign a specific time slot for each of the machine learning models and schedule the models when to be run. For example, a device (e.g., smart camera) deployed at a coffee shop can have three different tasks to perform: determining the number of customers, determining the number of baristas, and detecting if customers are wearing masks. Each task can be given a specific time slot so that each of the three machine learning models can run based on the order of the assigned time slot.

In another example, a time-based rule can include defining a time slice between running the first machine learning model and running the second machine learning model.

Furthermore, the set of rules can be context-based. A model can be scheduled to run based on the prediction or output of the currently deployed machine learning model. For example, in a coffee shop, a different machine learning model can be deployed based on the lighting conditions. A first machine learning model can be run to determine the lighting conditions. Then, based on the output of the first machine learning model (e.g., low, medium, high), a second machine learning model can be scheduled to run. If the output of the first machine learning model predicts that the lighting condition is deteriorating, such prediction can be used to schedule a second machine learning model to run.

In some instances, more than one rule (e.g., a combination of context-based, environment-based, or time-based rules) can be deployed to schedule the running of the multiple machine learning models. For example, for the first one minute, an object detection machine learning model can be scheduled to run. For the next 30 seconds, a headcount machine learning model can be scheduled to run. Then, after a ten-second break, for 30 seconds, based on the number of headcounts, a face detection machine learning model can be scheduled to run.

In another example, four different models can be deployed for a cup detector: a lighting condition detector model, which runs always in the time slices, a second model for a low lighting condition, a third model for a daylight condition, and a fourth model for a nightlight condition. Every 10 seconds, the lighting condition detector model can be run and generate an output, which will then be provided to a scheduler (e.g., scheduler 106 as illustrated in FIG. 1). Based on the output of the lighting condition detector model, the scheduler can determine which model, for a low lighting condition, a daylight condition, or a nightlight condition, to be loaded up for the next 10 seconds.

Furthermore, the prediction from the currently running machine learning model can be communicated to an external agent (e.g., workflow editor 104 as illustrated in FIG. 1), which then prepares and loads up a new personalized model. More specifically, a second machine learning model can be downloaded onto a device at any time. For example, based on the output of the first machine learning model, analytics runner 210 may determine that a different machine learning model needs to be run on the device. If the machine learning model is not available on its system, analytics runner 210 can obtain and download it from a cloud. In another example in a coffee shop setting, a first machine learning model (i.e., a base model) can detect store employees. Once detected, the machine learning model scheduling system can download a different set of personalized models for the persons that have been detected.

In some instances, the scheduling can be based on a simple round-robin method (i.e., assigning the machine learning models in equal portions and in circular order and processing them without priority) or a weighted round-robin method (i.e., assigning the models in weighted portions and in a cyclic way and processing them).

This way, the output of one machine learning model on a device may be used as input of another machine learning model on the device and/or multiple machine learning models may execute in parallel on the same device. As follows, an unlimited number of machine learning models can execute simultaneously on the same device, or as many as a compute power of the device allows. Also, each of the multiple machine learning models may think that they are running on the GPU/CPU.

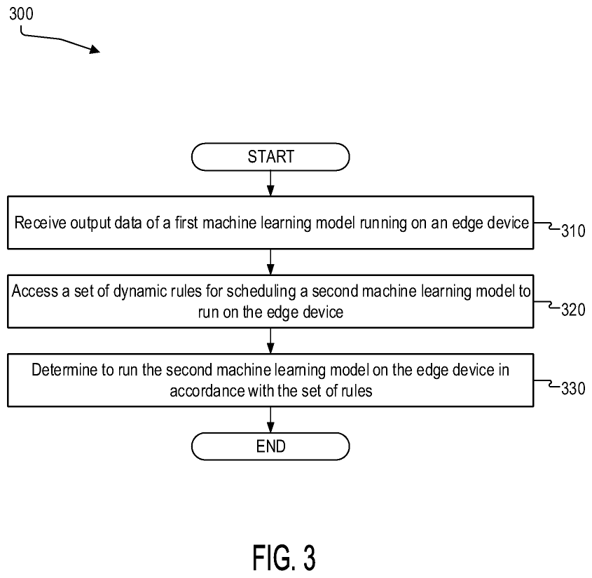

FIG. 3 is a flowchart of an example method 300 of running multiple learning models simultaneously on an edge device. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements the method 300 may perform functions at substantially the same time or in a specific sequence.

According to some examples, at step 310, method 300 includes receiving output data of a first machine learning model running on an edge device. For example, scheduler 106 as illustrated in FIG. 1 can receive output data of a first machine learning model (e.g., predictions 112 as illustrated in FIG. 1) running on an edge device.

At step 320, method 300 includes accessing a set of dynamic rules for scheduling a second machine learning model to run on the edge device. For example, scheduler 106 as illustrated in FIG. 1 can access a set of dynamic rules (e.g., rule set 204 as illustrated in FIG. 2) for scheduling a second machine learning model to run on the same edge device.

In some examples, the set of rules can include time-based rules such as assigning a time slot for machine learning model(s). For example, scheduler 106 as illustrated in FIG. 1 can assign a specific time slot for each of the machine learning models and schedule the models when to be run.

In some instances, the set of rules can include time-based rules such as defining a time slice between running the first machine learning model and running the second machine learning model. For example, scheduler 106 as illustrated in FIG. 1 can define a time slice between running the first machine learning model and running the second machine learning model.

In some implementations, the set of rules can include context-based rules such as analyzing the output data of the first machine learning model to determine a context associated with the edge device. For example, scheduler 106 as illustrated in FIG. 1 can analyze the output of the first machine learning model (e.g., predictions 112 as illustrated in FIG. 1) to determine a context associated with the edge device. As follows, predictions 112 can be used by scheduler 106 to determine which machine learning model needs to be loaded up to run on the edge device.

In some examples, the set of rules can comprise external factors. Further, the second machine learning model is designed specific to the external factors.

At step 330, method 300 includes determining to run the second machine learning model on the edge device in accordance with the set of rules in response to receiving the output data of the first machine learning model where the first machine learning model and the second machine learning model are run on the edge device in parallel. For example, scheduler 106 as illustrated in FIG. 1 can determine to run the second machine learning model on the edge device in accordance with rule set 204 as illustrated in FIG. 2 in response to receiving the output data of the first machine learning model (e.g., predictions 112 as illustrated in FIG. 1). The first machine learning model and the second machine learning model are run on the same edge device in parallel.

In some aspects, method 300 further includes examining model templates including information associated with multiple machine learning models that can be downloaded onto the edge device. The multiple machine learning models can include the second machine learning model. For example, scheduler 106 as illustrated in FIG. 1 can examine templates 102 including information associated with multiple machine learning models that may be downloaded onto the device to be run on the device. Further, workflow editor 104 may build and design a personalized machine learning model based on the output of the first machine learning model or a set of rules so that scheduler 106 can receive the personalized machine learning model from workflow editor 104 and schedule the model to run on the device.

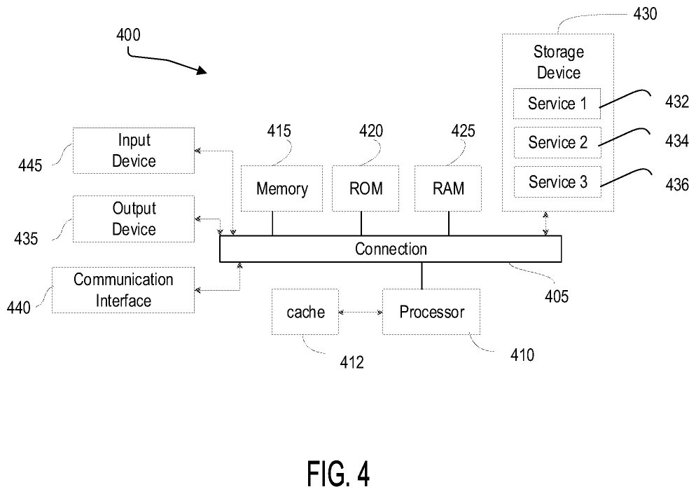

FIG. 4 illustrates an example computing system 400 including components in electrical communication with each other using a connection 405 upon which one or more aspects of the present disclosure can be implemented. Connection 405 can be a physical connection via a bus, or a direct connection into processor 410, such as in a chipset architecture. Connection 405 can also be a virtual connection, networked connection, or logical connection.

In some embodiments computing system 400 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

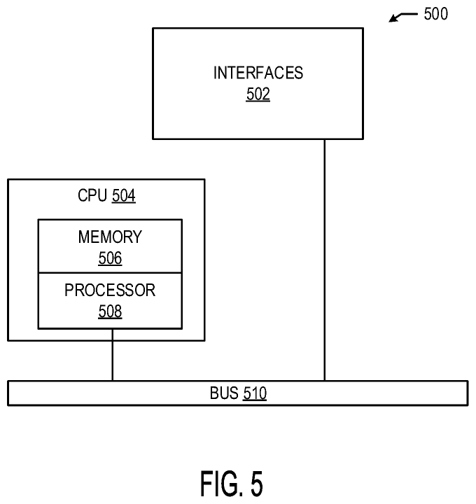

FIG. 5 illustrates an example network device 500 suitable for performing switching, routing, load balancing, and other networking operations. Network device 500 includes a central processing unit (CPU) 504, interfaces 502, and a bus 510 (e.g., a PCI bus). When acting under the control of appropriate software or firmware, the CPU 504 is responsible for executing packet management, error detection, and/or routing functions. The CPU 504 preferably accomplishes all these functions under the control of software including an operating system and any appropriate applications software. CPU 504 may include one or more processors 508, such as a processor from the INTEL X86 family of microprocessors. In some cases, processor 508 can be specially designed hardware for controlling the operations of network device 500. In some cases, a memory 506 (e.g., non-volatile RAM, ROM, etc.) also forms part of CPU 504. However, there are many different ways in which memory could be coupled to the system.

The interfaces 502 are typically provided as modular interface cards (sometimes referred to as “line cards”). Generally, they control the sending and receiving of data packets over the network and sometimes support other peripherals used with the network device 500. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU 504 to efficiently perform routing computations, network diagnostics, security functions, etc.

Although the system shown in FIG. 5 is one specific network device of the present technology, it is by no means the only network device architecture on which the present technology can be implemented. For example, an architecture having a single processor that handles communications as well as routing computations, etc., is often used. Further, other types of interfaces and media could also be used with the network device 500.

Regardless of the network device's configuration, it may employ one or more memories or memory modules (including memory 506) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 506 could also hold various software containers and virtualized execution environments and data.

The network device 500 can also include an application-specific integrated circuit (ASIC), which can be configured to perform routing and/or switching operations. The ASIC can communicate with other components in the network device 500 via the bus 510, to exchange data and signals and coordinate various types of operations by the network device 500, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
receiving output data of a first machine learning model running on an edge device;
accessing a set of dynamic rules for scheduling a second machine learning model to run on the edge device; and
in response to receiving the output data of the first machine learning model, determining to run the second machine learning model on the edge device in accordance with the set of rules, wherein the first machine learning model and the second machine learning model are run on the edge device in parallel.

2. The method of claim 1, wherein the set of rules includes time-based rules, the method further comprising:
assigning a time slot for each of the first machine learning model and the second machine learning model that run on the edge device in parallel.

3. The method of claim 1, wherein the set of rules includes time-based rules, the method further comprising:
defining a time slice between running the first machine learning model and running the second machine learning model.

4. The method of claim 1, wherein the set of rules includes context-based rules, the method further comprising:
analyzing the output data of the first machine learning model to determine a context associated with the edge device.

5. The method of claim 1, wherein the set of rules comprises external factors.

6. The method of claim 5, wherein the second machine learning model is designed specific to the external factors.

7. The method of claim 1, further comprising:
examining model templates including information associated with multiple machine learning models that can be downloaded onto the edge device, wherein the multiple machine learning models include the second machine learning model.

8. A system comprising:
one or more processors; and
a computer-readable medium comprising instructions stored therein, which when executed by the one or more processors, cause the one or more processors to:
receive output data of a first machine learning model running on an edge device;
access a set of dynamic rules for scheduling a second machine learning model to run on the edge device; and
in response to receiving the output data of the first machine learning model, determine to run the second machine learning model on the edge device in accordance with the set of rules, wherein the first machine learning model and the second machine learning model are run on the edge device in parallel.

9. The system of claim 8, wherein the instructions, which when executed by the one or more processors, further cause the one or more processors to:
assign a time slot for each of the first machine learning model and the second machine learning model that run on the edge device in parallel.

10. The system of claim 8, wherein the instructions, which when executed by the one or more processors, further cause the one or more processors to:
define a time slice between running the first machine learning model and running the second machine learning model.

11. The system of claim 8, wherein the instructions, which when executed by the one or more processors, further cause the one or more processors to:
analyze the output data of the first machine learning model to determine a context associated with the edge device.

12. The system of claim 8, wherein the set of rules comprises external factors.

13. The system of claim 12, wherein the second machine learning model is designed specific to the external factors.

14. The system of claim 8, wherein the instructions, which when executed by the one or more processors, further cause the one or more processors to:
examine model templates including information associated with multiple machine learning models that can be downloaded onto the edge device, wherein the multiple machine learning models include the second machine learning model.

15. A non-transitory computer-readable storage medium comprising computer-readable instructions, which when executed by a computing system, cause the computing system to:
receive output data of a first machine learning model running on an edge device;
access a set of dynamic rules for scheduling a second machine learning model to run on the edge device; and
in response to receiving the output data of the first machine learning model, determine to run the second machine learning model on the edge device in accordance with the set of rules, wherein the first machine learning model and the second machine learning model are run on the edge device in parallel.

16. The non-transitory computer-readable storage medium of claim 15, wherein the instructions, which when executed by the computing system, further cause the computing system to:
assign a time slot for each of the first machine learning model and the second machine learning model that run on the edge device in parallel.

17. The non-transitory computer-readable storage medium of claim 15, wherein the instructions, which when executed by the computing system, further cause the computing system to:
define a time slice between running the first machine learning model and running the second machine learning model.

18. The non-transitory computer-readable storage medium of claim 15, wherein the instructions, which when executed by the computing system, further cause the computing system to:
analyze the output data of the first machine learning model to determine a context associated with the edge device.

19. The non-transitory computer-readable storage medium of claim 15, wherein the set of rules comprises external factors and the second machine learning model is designed specific to the external factors.

20. The non-transitory computer-readable storage medium of claim 15, wherein the instructions, which when executed by the computing system, further cause the computing system to:
examine model templates including information associated with multiple machine learning models that can be downloaded onto the edge device, wherein the multiple machine learning models include the second machine learning model.
